(19) United States
(12) Patent Application Publication
(10) Pub. No.: US 2023/0075457 A1
(43) Pub. Date: Mar. 9, 2023

(54) INFORMATION PROCESSING CIRCUIT

(71) Applicant: NEC Corporation, Minato-ku, Tokyo (JP)

(72) Inventors: Katsuhiko TAKAHASHI, Tokyo (JP); Takashi Takenaka, Tokyo (JP)

(73) Assignee: NEC Corporation, Minato-ku, Tokyo (JP)

(21) Appl. No.: 17/796,329

(22) PCT Filed: Feb. 14, 2020
(86) PCT No.: PCT/JP2020/005733

§ 371 Date: Jul. 29, 2022

(51) Int. Cl. G06F 7/544; G06F 7/50; G06F 9/50

(52) U.S. Cl. CPC G06F 7/5443; G06F 7/50; G06F 9/5027

(57) ABSTRACT

The information processing circuit 80 includes a first information processing circuit 81 that performs layer operations in deep learning, a second information processing circuit 82 that performs the layer operations in deep learning on input data by means of a programmable accelerator, and an integration circuit 83 integrates a calculation result of the first information processing circuit 81 with a calculation result of the second information processing circuit 82, and output an integration result, wherein the first information processing circuit 81 includes a parameter value output circuit 811 in which parameters of deep learning are circuited, and a sum-of-product circuit 812 that performs a sum-of-product operation using the input data and the parameters.

### TECHNICAL FIELD

This invention relates to an information processing circuit that performs the inference phase of deep learning, a deep learning method, and a storage medium that stores a program that performs deep learning.

### BACKGROUND ART

Deep learning is an algorithm that uses a multi-layer neural network (hereafter referred to as a “network”). Deep learning involves a learning phase in which each network (layer) is optimized to create a model (learned model), and an inference phase in which inference is made based on the learned model. The model is sometimes referred to as an inference model. The model may also be referred to as an inference unit in the following.

During the learning and inference phases, operations are performed to adjust the weights as parameters of a CNN (Convolutional Neural Network), and operations are performed on the input data and weights. The calculation amount of these operations is large. As a result, the processing time for each phase is long.

In order to accelerate deep learning, the inference unit realized by a GPU (Graphics Processing Unit) is often used rather than the inference unit realized by a CPU (Central Processing Unit). In addition, accelerators dedicated to deep learning have been put to practical use.

Patent literature 1 describes dedicated hardware designed for deep neural network (DNN). The device described in patent literature 1 improves various limitations of hardware solutions for DNNs, including large power consumption, long latency, a large silicon area requirement, etc. In addition, non-patent literature 1 describes the Mixture of experts method.

### CITATION LIST

### Patent Literature

PTL 1: Japanese Patent Laid-Open No. 2020-4398

### Non Patent Literature

NPL 1: Robert Jacobs et al., “Adaptive Mixtures of Local Experts”, Neural Computation, vol. 3, February 1991, p. 79-87

### SUMMARY OF INVENTION

### Technical Problem

In the dedicated hardware described in patent literature 1, the DNN has a fixed circuit configuration. Therefore, even if training data is later increased and a more advanced DNN can be constructed using that data, it is difficult to change the circuit configuration of the DNN.

It is an object of the present invention to provide an information processing circuit, a deep learning method, and a storage medium storing a program for performing deep learning, which can change the input/output characteristics of a network without changing a hardware circuit configuration, even when an inference unit has a fixed circuit configuration in hardware.

### Solution to Problem

The information processing circuit according to the present invention includes a first information processing circuit that performs layer operations in deep learning, a second information processing circuit that performs the layer operations in deep learning on input data by means of a programmable accelerator, and an integration circuit integrates a calculation result of the first information processing circuit with a calculation result of the second information processing circuit, and output an integration result, wherein the first information processing circuit includes a parameter value output circuit in which parameters of deep learning are circuited, and a sum-of-product circuit that performs a sum-of-product operation using the input data and the parameters.

The deep learning method according to the present invention includes integrating first calculation results of layer operations in deep learning by a first information processing circuit which includes a parameter value output circuit in which parameters of deep learning are circuited and a sum-of-product circuit that performs a sum-of-product operation using input data and parameters, and second calculation results by a second information processing circuit as a programmable accelerator that performs the layer operations in deep learning using the input data, and outputting an integration result.

The program executing deep learning according to the present invention causes a processor to execute an integration process integrating first calculation results of layer operations in deep learning by a first information processing circuit which includes a parameter value output circuit in which parameters of deep learning are circuited and a sum-of-product circuit that performs a sum-of-product operation using input data and parameters, and second calculation results by a second information processing circuit as a programmable accelerator that performs the layer operations in deep learning using the input data, and outputting an integration result.

### Advantageous Effects of Invention

According to the present invention, even if the reasoner has a fixed circuit configuration in hardware, it is possible to obtain an information processing circuit that can change the input/output characteristics of the network without changing the hardware circuit configuration.

### BRIEF DESCRIPTION OF DRAWINGS

FIG. 1 It depicts an explanatory diagram schematically showing the information processing circuit of the first example embodiment.

FIG. 2 It depicts an explanatory diagram schematically showing the inference unit of CNN with an operator corresponding to each layer.

FIG. 3 It depicts an explanatory diagram schematically showing the inference unit of CNN configured so that operations of multiple layers are performed by a common operator.

FIG. 4 It depicts a block diagram showing an example of a computer with a CPU.

FIG. 5 It depicts a flowchart showing an operation of the information processing circuit of the first example embodiment.

FIG. 6 It depicts an explanatory diagram schematically showing the information processing circuit of the second example embodiment.

FIG. 7 It depicts a flowchart showing an operation of the information processing circuit of the second example embodiment.

FIG. 8 It depicts an explanatory diagram schematically showing the information processing circuit of the third example embodiment.

FIG. 9 It depicts an explanatory diagram schematically showing the information processing circuit of the fourth example embodiment.

FIG. 10 It depicts an explanatory diagram schematically showing the information processing circuit of the fifth example embodiment.

FIG. 11 It depicts an explanatory diagram schematically showing the information processing circuit of the sixth example embodiment.

FIG. 12 It depicts a block diagram showing the main part of the information processing circuit.

### DESCRIPTION OF EMBODIMENTS

Hereinafter, example embodiments of the present invention are described with reference to the drawings. The following is an example in which the information processing circuit comprises a plurality of inference units of CNN. In addition, an image (image data) is used as an example of data input to the information processing circuit.

### Example Embodiment 1

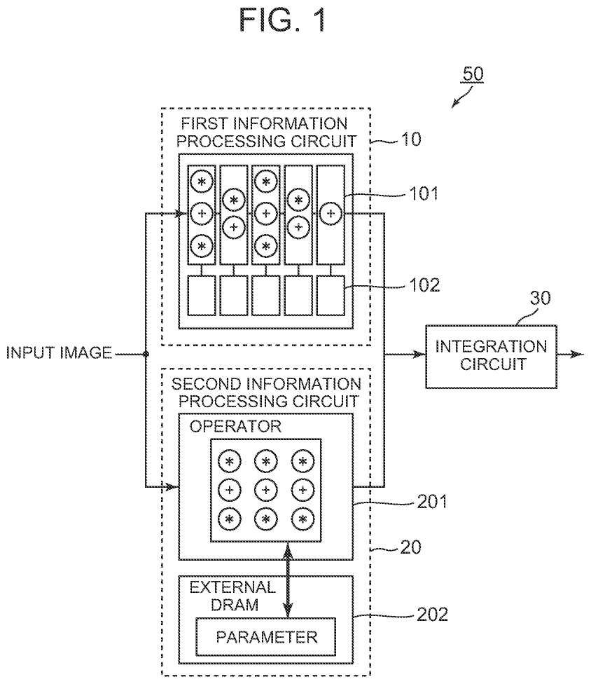

FIG. 1 is an explanatory diagram schematically showing the information processing circuit 50 of the first example embodiment. The information processing circuit 50 includes a first information processing circuit 10 that implements a CNN, a second information processing circuit 20 that implements a CNN, and an integration circuit 30. The first information processing circuit 10 is an inference unit with fixed operators (circuits) corresponding to the layers and parameters. The second information processing circuit 20 is a programmable inference unit.

In FIG. 1, “+” indicates an adder. The “*” denotes a multiplier. The number of adders and multipliers shown in the blocks shown in FIG. 1 are merely examples for expression.

The first information processing circuit 10 includes a plurality of sum-of-product circuits 101 and parameter value output circuits 102. The first information processing circuit 10 is an inference unit of CNN having operators corresponding to respective layers of the CNN. The first information processing circuit 10 realizes an inference unit of CNN whose parameters are fixed and network configuration (type of deep learning algorithm, how many layers of what type and in what order, input data size and output data size for each layer). In other words, the first information processing circuit 10 includes sum-of-product circuits 101 each specializing in each layer of the CNN (for example, each of the convolutional and fully connected layers). The term of specializing means that it is a dedicated circuit entirely performs the operation for corresponding layer.

The parameters are fixed means that at the time of creation of the first information processing circuit 10, the learning phase process is completed, the appropriate parameters are determined, and the determined parameters are used. The circuit in which the parameters are fixed is the parameter value output circuit 102.

The second information processing circuit 20 includes an operator 201 and an external memory 20. The second information processing circuit 20 is a programmable inference unit of CNN. The second information processing circuit 20 has an external memory 202 that holds parameters. However, the parameters may be changed to parameter values determined during the learning phase in the processing of the information processing circuit 50. The learning method is described below.

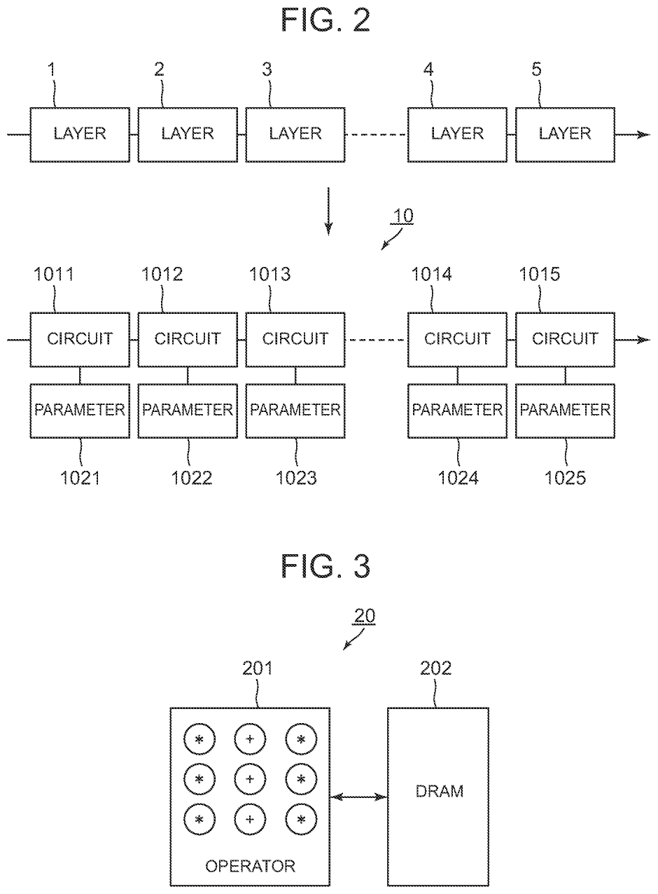

FIG. 2 is an explanatory diagram showing an example of the first information processing circuit 10 that performs operations on layers in deep learning. FIG. 2 schematically shows the inference unit of CNN with an operator corresponding to each layer. FIG. 2 shows five layers 1, 2, 3, 4, and 5. The operator (circuit) 1011, 1012, 1013, 1014, and 1015 corresponding to each of layers 1, 2, 3, 4, and 5 are provided in the inference unit. In addition, the parameters 1021, 1022, 1023, 1024, and 1025 corresponding to each of layers 1, 2, 3, 4, and 5 are set corresponding to the arithmetic unit (circuit). Since the operators (circuits) 1011 to 1015 perform operations of corresponding layers 1-5, the configurations of the operators are fixed when the parameters 1021-1025 are constant. The fixed circuits 1011-1015 correspond to sum-of-product circuits 101. Similarly, the parameters are fixedly configured. The circuits that output the fixed parameters 1021-1025 corresponds to the parameter value output circuits 102.

FIG. 3 an explanatory diagram showing an example of the second information processing circuit that uses a programmable accelerator to perform operations of layers in deep learning on input data. FIG. 3 schematically shows the inference unit of CNN configured so that operations of multiple layers are performed by a common operator. The part performing operations in the inference unit comprises an operator 201 and a memory (for example, DRAM (Dynamic Random Access Memory)) 202. In the operator 201 shown in FIG. 3, a large number of adders and a large number of multipliers are formed. In FIG. 3, “+” indicates an adder and “*” indicates a multiplier. Although three adders and six multipliers are shown in FIG. 3, the number of adders and multipliers which can perform each operation in all layers in a CNN are formed. The inference unit shown in FIG. 3 is a programmable accelerator.

The integration circuit 30 integrates calculation results of the first information processing circuit 10 and the second information processing circuit 2 and outputs the integration result. A simple average or a weighted sum is available as an integration. In this example embodiment, the integration circuit 30 integrates calculation results by a simple average or a weighted sum. In this example embodiment, the weighted sum is predetermined to an arbitrary value based on experiments and past integration results. The integration circuit 30 has a parameter holding unit (not shown) such as an external memory. The integration circuit 30 accepts an output of the first information processing circuit and an output of the second information processing circuit as inputs to the layers in deep learning, and outputs a calculation result based on the accepted inputs as an integration result. In this example embodiment, the parameters may be changed to the parameter values determined during the learning phase in the processing of the information processing circuit 50. The integration circuit 30 may be a programmable accelerator.

The parameters in deep learning used by the second information processing circuit and the integration circuit are determined in advance by learning. For example, there are three learning methods used when constructing the second information processing circuit and the integration circuit as shown below.

The first method is to learn the parameters of the second information processing circuit independently, then construct the whole circuit, and adjust the parameters of the second information processing circuit again. This method is characterized by the fact that it does not require learning of the integration circuit, making learning easy. However, the recognition accuracy is the lowest among the three methods.

The second method is to learn the parameters of the second information processing circuit independently, then construct the whole circuit, and adjust the integration circuit (and also the parameters of the second information processing circuit) again. One of the characteristics of this method is that the parameters of the second information processing circuit are learned independently. Therefore, this method involves learning the parameters of the second information processing circuit twice. However, since the parameters of the second information processing circuit are set to some good values in this method, the learning effort after the whole circuit is constructed is small.

The third method is to learn the parameters of the second information processing circuit and the integration circuit at the same time. One of the characteristics of this method is that the parameters of the second information processing circuit are not learned twice. However, this method requires more time for learning after the whole circuit is constructed compared to the second method.

The second information processing circuit 20 and the integration circuit 30 shown in FIG. 1 can be configured by one hardware or one software. Each component can also be configured by multiple hardware or multiple software. It is also possible to configure a part of each component in hardware and the other part in software.

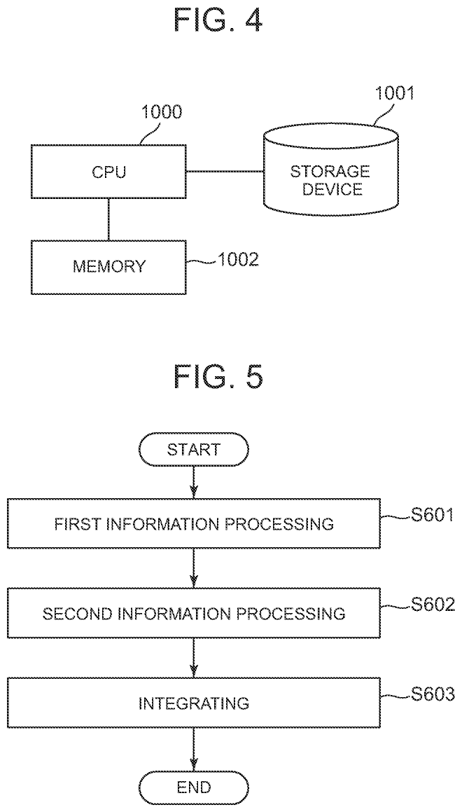

FIG. 4 is a block diagram showing an example of a computer with a CP. When each component in the second information processing circuit 20 and the integration circuit 30 is realized by a computer having a CPU (Central Processing Unit) and a memory, the computer with a CPU shown in FIG. 4 can realize each component. FIG. 4 shows a storage device 1001 and a memory 1002 connected to the CPU 1000. The CPU 1000 realizes each function in the second information processing circuit 20 and the integration circuit 30 by executing the processing (integration processing) in accordance with a program stored in the storage device 1001. In other words, the computer realizes each function in the second information processing circuit 20 and the integration circuit 30 in the information processing circuit 50 shown in FIG. 1.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disc), a compact disc-read only memory (CD-ROM), a compact disc-recordable (CD-R), a compact disc-rewritable (CD-R/W), and a semiconductor memory (for example, a mask ROM, a programmable ROM (PROM), an erasable PROM (EPROM), a flash ROM).

The program may be stored in various types of transitory computer readable media. The transitory computer readable medium is supplied with the program through, for example, a wired or wireless communication channel, or, through electric signals, optical signals, or electromagnetic waves.

The memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

Next, the operation of the information processing circuit 50 will be described with reference to the flowchart of FIG. 5. FIG. 5 is a flowchart showing an operation of the information processing circuit 50 of the first example embodiment. The flowchart in FIG. 5 shows the inference phase in the CNN.

The first information processing circuit 10 performs layer operations in deep learning. Specifically, the first information processing circuit 10 performs sum-of-product operations in sequence on input data such as an input image, in each layer that constitutes a CNN, using the parameters output from the sum-of-product circuit 101 and the parameter value output circuit 102 corresponding to each layer. After the operation is completed, the first information processing circuit 10 outputs the calculation result to the integration circuit 30 (step S601).

One of the concepts of network structure in this example embodiment is the type of deep learning algorithm, such as AlexNet, GoogLeNet, ResNet (Residual Network), SENet (Squeeze-and-Excitation Networks) MobileNet, the VGG-16, and VGG-19. As the number of layers, which is one of the concepts of network structure, for example, the number of layers based on the type of deep learning algorithm may be. used In addition, the concept of network structure could include filter size.

The second information processing circuit 20 performs layer operations in deep learning on input data by means of a programmable accelerator. Specifically, the second information processing circuit 20 performs a sum-of-product operation using shared operator 20 on input data similar to the input data input to the first information processing circuit 10, using parameters read from external memory (DRAM). After the calculation is completed, the second information processing circuit 20 outputs the calculation result to the integration circuit 30 (step S602).

The integration circuit 30 integrates the calculation result output from the first information processing circuit 10 with the calculation result output from the second information processing circuit 20 (step S603). In this example embodiment, the integration is performed by simple average or weighted sum. The integration circuit 30 then outputs the integration result to outside.

It should be noted that in the flowchart of FIG. 5, the processes of steps S601-S602 are executed sequentially, but can be executed in parallel.

As explained above, the information processing circuit 50 of this example embodiment comprises the first information processing circuit 10, including the parameter value output circuit 102 in which parameters of deep learning are circuited and the sum-of-product circuit 101 that performs a sum-of-product operation using input data and the parameters, that performs the operations of the layers in deep learning, and the second information processing circuit 20 that performs the operations of the layers in deep learning on the input data by means of a programmable accelerator. As a result, the input/output characteristics of the network can be changed without modifying the hardware circuit configuration, even if the inference unit (first information processing circuit 10) has a fixed hardware circuit configuration. In addition, the information processing circuit 50 of this example embodiment improves the processing speed compared to an information processing circuit configured only with a programmable accelerator configured to read the parameter values from memory shown in FIG. 3. Further, the information processing circuit 50 of this example embodiment is smaller in circuit size compared to an information processing circuit configured only with a programmable accelerator. As a result, power consumption is reduced.

Although the information processing circuit is described in this example embodiment using a plurality of inference units of CNN as an example, it could be inference units of any other neural network. In addition, although image data is used as input data in this example embodiment, networks that use input data other than image data can also utilize this example embodiment.

### Example Embodiment 2

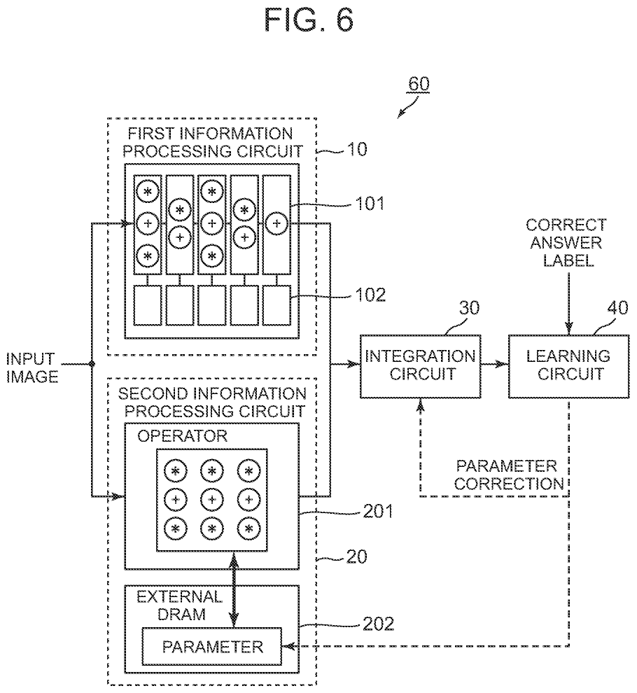

FIG. 6 is an explanatory diagram schematically showing the information processing circuit 60 of the second example embodiment. The information processing circuit 60 of this example embodiment includes the information processing circuit 50 of the first example embodiment. The information processing circuit 60 includes a first information processing circuit 10 that implements a CNN, a second information processing circuit 20 that implements a CNN, an integration circuit 30, and a learning circuit 40. The configuration of the circuits other than the learning circuit 40 is the same as that of the information processing circuit 50 of the first example embodiment, and therefore, the description is omitted.

The learning circuit 40 shown in FIG. 6 can be configured by one hardware or one software as with the second information processing circuit 20 and the integration circuit 30. Each component can also be configured by multiple hardware or multiple software. It is also possible to configure a part of each component in hardware and the other part in software.

The learning circuit 40 accepts as input the calculation result output by the integration circuit 30 integrated to the input data and a correct answer label for the input data. The learning circuit 40 calculates a loss based on a difference between the calculation result output by the integration circuit 30 and the correct answer label, and corrects (modifies) at least one of the parameters of the second information processing circuit 20 and the integration circuit 30. The learning method of the second information processing circuit 20 and the integration circuit 30 is arbitrary. The Mixture of experts method or the like is usable. The loss is determined by a loss function. The value of the loss function is calculated by the difference (for example, L2 norm or cross entropy) between the output (numeric vector) of the integration circuit 30 and the correct answer label (numeric vector).

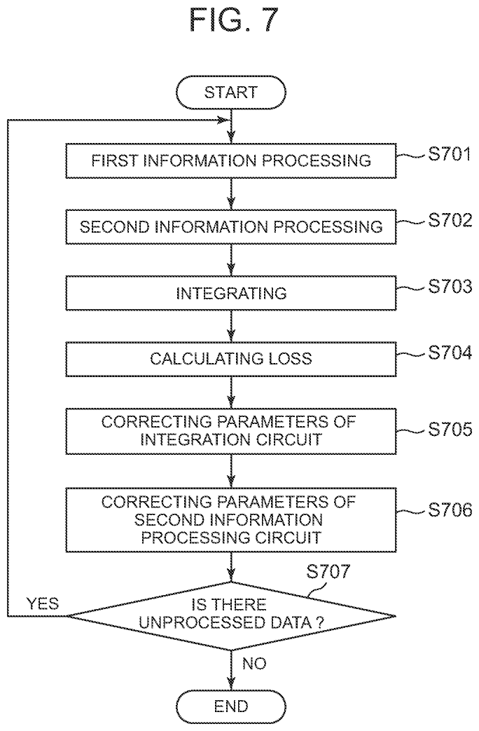

Next, the operation of the information processing circuit 60 is described with reference to the flowchart in FIG. 7. FIG. 7 is a flowchart showing the operation of the information processing circuit 60 in the second example embodiment. The flowchart in FIG. 7 can be said to show the learning phase in the CNN.

Steps S701 to S703 are the same processes as steps S601 to S603 in the flowchart for the information processing circuit 50 of the first example embodiment, and therefore, the description is omitted.

The learning circuit 40 accepts as input the calculation result output by the integration circuit 30 integrated to the input data and the correct answer label for the input data. The learning circuit 40 calculates the loss based on the difference between the calculation result output by the integration circuit 30 and the correct answer label (step S704).

The learning circuit 40 corrects (modifies) at least one of the parameters of the second information processing circuit 20 and the integration circuit 30 so that the value of the loss function becomes smaller (step S705 and step S706).

When there is unprocessed data (NO in step S707), the information processing circuit 50 repeats steps S701 to S 706 until there is no more unprocessed data. When there is no more unprocessed data (YES in step S707), the information processing circuit 50 terminates processes.

It should be noted that in the flowchart of FIG. 7, the processes of steps S605-S606 are executed sequentially, but can be executed in parallel.

As explained above, the information processing circuit 60 of this example embodiment comprises the learning circuit 40 that accepts the calculation result for input data of the integration circuit 30 and the correct answer label for the input data, and the learning circuit 40 corrects at least one of the parameters of the second information processing circuit 20 and the integration circuit 30 based on the difference between the calculation result and the correct answer label. As a result, the information processing circuit 60 of this example embodiment can improve recognition accuracy.

### Example Embodiment 3

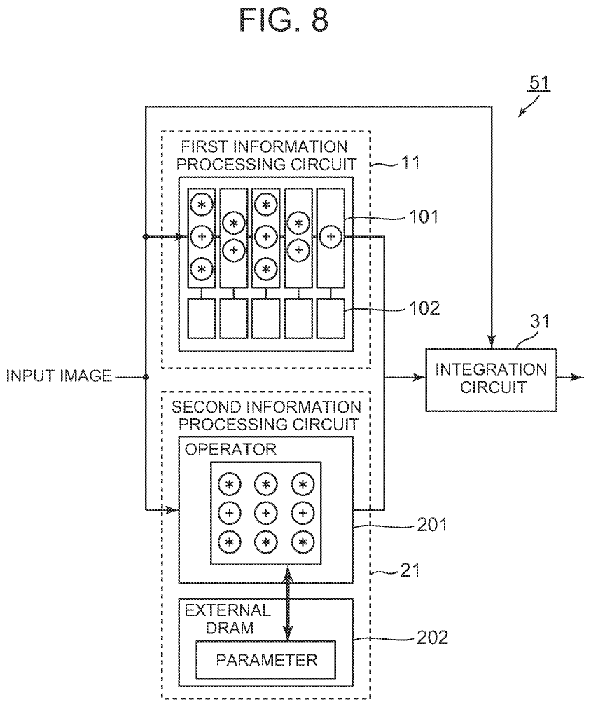

FIG. 8 is an explanatory diagram schematically showing the information processing circuit 51 of the third example embodiment. The information processing circuit 51 includes a first information processing circuit 11 that implements a CNN, a second information processing circuit 21 that implements a CNN, and an integration circuit 31. The first information processing circuit 11 and the second information processing circuit 21 are the same as the first information processing circuit 10 and the second information processing circuit 20 of the first example embodiment, and therefore, the description is omitted.

In the information processing circuit 51 of this example embodiment, input data is input to the integration circuit 31. Other inputs and outputs are the same as those to the information processing circuit 50 in the first example embodiment.

The integration circuit 31 inputs the same data as the input data accepted by the first information processing circuit 11 and the second information processing circuit 21. The integration circuit 31 then weights calculation results of the first information processing circuit 11 and the second information processing circuit 21 based on weighting parameters determined according to the input data.

The weighting parameters are determined by learning performed in advance based on discriminative characteristics for the input data of the first information processing circuit 11 and the second information processing circuit 21, for example. In other words, it can also be said that the weighting parameters are determined based on the strengths and weaknesses of the first information processing circuit 11 and the second information processing circuit 21. Therefore, the higher the discrimination accuracy with respect to the input data, the larger the weighting parameter is determined.

For example, assuming that the first information processing circuit 11 is good at detecting apples and the second information processing circuit 21 is good at detecting oranges. When the input data is able to detect apple-like characteristics, the integration circuit 31 assigns a larger weight to the first information processing circuit 11 than a weight to the second information processing circuit 21. The integration circuit 31 accepts the calculation results of the first information processing circuit 11 and the second information processing circuit 21 as inputs, integrates the calculation results by calculating a weighted sum of accepted inputs, and output the integration result.

As explained above, in the information processing circuit 51 of this example embodiment, the integration circuit 31 inputs input data and, based on weighting parameters determined according to the input data, weights the calculation results of the first information processing circuit 11 and the second information processing circuit 21. Since the information processing circuit 51 of this example embodiment performs weighting while predicting the strengths and weaknesses of the first information processing circuit 11 and the second information processing circuit 21 to the input data, the recognition accuracy can be higher than that in the first example embodiment.

### Example Embodiment 4

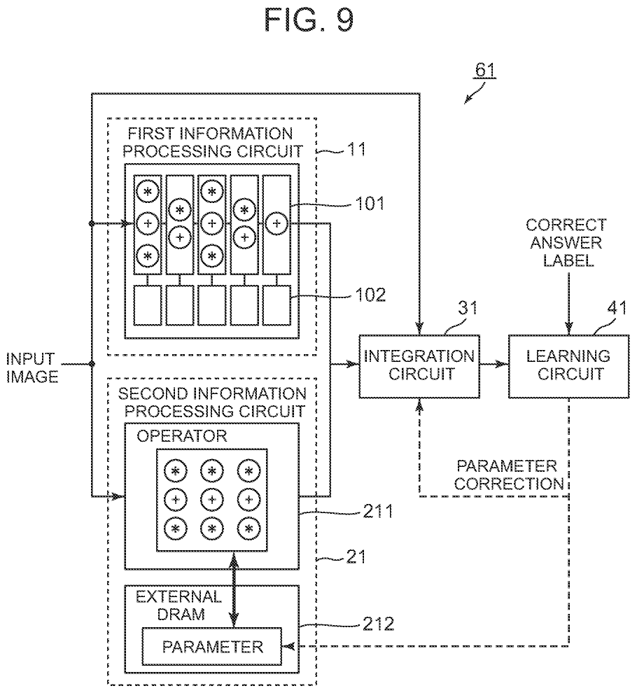

FIG. 9 is an explanatory diagram schematically showing the information processing circuit 52 of the fourth example embodiment. The information processing circuit 61 of this example embodiment includes the information processing circuit 51 of the third example embodiment. The information processing circuit 61 includes a first information processing circuit 11 that implements a CNN, a second information processing circuit 21 that implements a CNN, an integration circuit 31, and a learning circuit Includes 41. The configuration of the circuits other than the learning circuit 41 is the same as that of the information processing circuit 51 of the third example embodiment, and therefore, the description is omitted.

The inputs and outputs of the learning circuit 41 are the same as those of the learning circuit 40 of the information processing circuit 60 of the second example embodiment. That is, the learning circuit 41 accepts as input the calculation result output by the integration circuit 31 for the input data and the correct answer label for the input data. The learning circuit 41 calculates a loss based on a difference between the calculation result output by the integration circuit 31 and the correct answer label, and corrects (modifies) at least one of the parameters of the second information processing circuit 21 and the integration circuit 31.

As explained above, the information processing circuit 61 of this example embodiment comprises the learning circuit 41 that accepts the calculation result for input data of the integration circuit 31 and the correct answer label for the input data, and the learning circuit 41 corrects at least one of the parameters of the second information processing circuit 21 and the integration circuit 31 based on the difference between the calculation result and the correct answer label. As a result, the information processing circuit 61 of this example embodiment can improve recognition accuracy.

### Example Embodiment 5

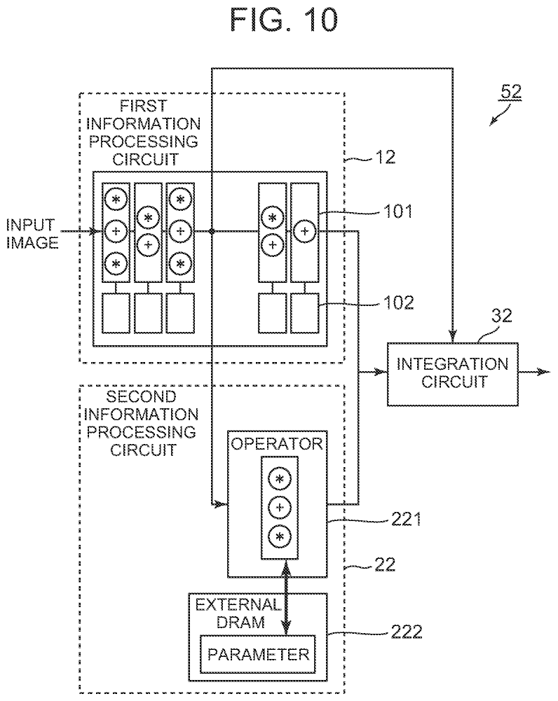

FIG. 10 is an explanatory diagram schematically showing the information processing circuit 52 of the fifth example embodiment. The information processing circuit 52 includes a first information processing circuit 12 that implements a CNN, a second information processing circuit 22 that implements a CNN, and an integration circuit 32.

The first information processing circuit 12 in this example embodiment outputs a calculation result of an intermediate layer in deep learning. Specifically, the first information processing circuit 12 outputs an output from the intermediate layer that performs feature extraction in deep learning as the calculation result. The intermediate layer that performs feature extraction is a clustered network called, for example, a backbone or feature pyramid network. The intermediate layer of the first information processing circuit 12 outputs the final result of such a clustered network. For example, a CNN such as ResNet-50, ResNet-101, VGG-16 or the like is used as the backbone. RetinaNet has a (resnet+) feature pyramid network exists as a cluster of feature extraction. The output from the intermediate layer is input to the second information processing circuit 22 and the integration circuit 32. In this example, the case in which the information processing circuit 52 outputs from the intermediate layer that performs feature extraction is shown, but the output from the intermediate layer can be from a layer other than the one that performs feature extraction.

The second information processing circuit 22 performs layer operations in deep learning using the calculation result of intermediate layer as input data. Specifically, the second information processing circuit 22 accepts input from the intermediate layer that performs feature extraction for the first information processing circuit 12. The feature extraction performed by the second information processing circuit 22 uses the output from the layer that performs feature extraction for the first information processing circuit 12. Therefore, the circuit scale of the second information processing circuit 22 in this example embodiment is smaller than that of the second information processing circuit 2 of the fourth example embodiment.

The integration circuit 32 accepts the feature extracted from the intermediate layer of the first information processing circuit 12. The integration circuit 32 weights the calculation results of the first information processing circuit 12 and the information processing circuit 22 based on weighting parameters determined according to the feature.

Similar to the case of the integration circuit 31 of the third example embodiment, the weighting parameters may be determined by learning performed in advance based on discriminative characteristics for the feature of the first information processing circuit 12 and the second information processing circuit 22.

For example, assuming that the first information processing circuit 12 is good at detecting pedestrians and the second information processing circuit 22 is good at detecting cars. When features indicating pedestrian-like characteristics are extracted from the input data, the integration circuit 32 assigns a larger weight to the first information processing circuit 12 than a weight to the second information processing circuit 22. The integration circuit 32 accepts the calculation results of the first information processing circuit 12 and the second information processing circuit 22 as inputs, integrates the calculation results by calculating a weighted sum of accepted inputs, and output the integration result.

As explained above, in the information processing circuit 52 in this example embodiment, the first information processing circuit 12 outputs the calculation result of intermediate layer in deep learning using the calculation result of the intermediate layer as input data. The integration circuit 32 integrates the calculation result of the intermediate layer, the calculation result of the first information processing circuit 12 and the calculation result of the second information processing circuit 22, and outputs the integration result. As a result, the information processing circuit 52 of this example embodiment can perform weighting based on the features extracted by the intermediate layer in the first information processing circuit 12, while predicting the strengths and weaknesses of the first information processing circuit 11 and the second information processing circuit 21. Therefore, the information processing circuit 52 of this example embodiment can increase recognition accuracy compared to the information processing circuit 50 of the first example embodiment. In addition, when feature extraction of the second information processing circuit 22 is shared with the first information processing circuit 12, the circuit size can be reduced compared to the information processing circuit 51 of the third example embodiment.

### Example Embodiment 6

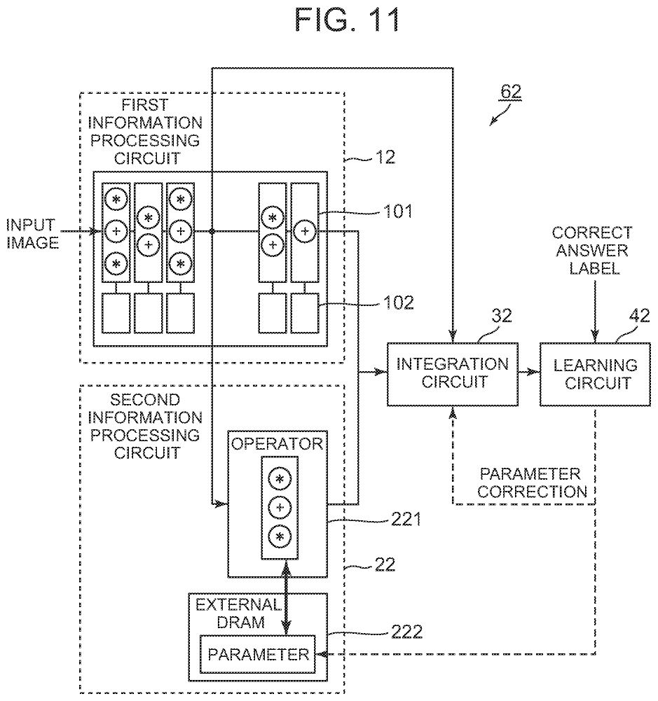

FIG. 11 is an explanatory diagram schematically showing the information processing circuit 62 of the sixth example embodiment. The information processing circuit 62 of this example embodiment includes the information processing circuit 52 of the fifth example embodiment. The information processing circuit 62 includes a first information processing circuit 12 that implements a CNN, a second information processing circuit 22 that implements a CNN, an integration circuit 32, and a learning circuit Includes 42. The configuration of the circuits other than the learning circuit 42 is the same as that of the information processing circuit 52 of the fifth example embodiment, and therefore, the description is omitted.

The inputs and outputs of the learning circuit 42 are the same as those of the learning circuit 40 of the information processing circuit 60 of the second example embodiment and the learning circuit 41 of the information processing circuit 61 of the fourth example embodiment. That is, the learning circuit 42 accepts as input the calculation result output by the integration circuit 32 for the input data and the correct answer label for the input data. The learning circuit 42 calculates a loss based on a difference between the calculation result output by the integration circuit 32 and the correct answer label, and corrects (modifies) at least one of the parameters of the second information processing circuit 22 and the integration circuit 32.

As explained above, the information processing circuit 62 of this example embodiment comprises the learning circuit 42 that accepts the calculation result for input data of the integration circuit 32 and the correct answer label for the input data, and the learning circuit 42 corrects at least one of the parameters of the second information processing circuit 22 and the integration circuit 32 based on the difference between the calculation result and the correct answer label. As a result, the information processing circuit 62 of this example embodiment can improve recognition accuracy.

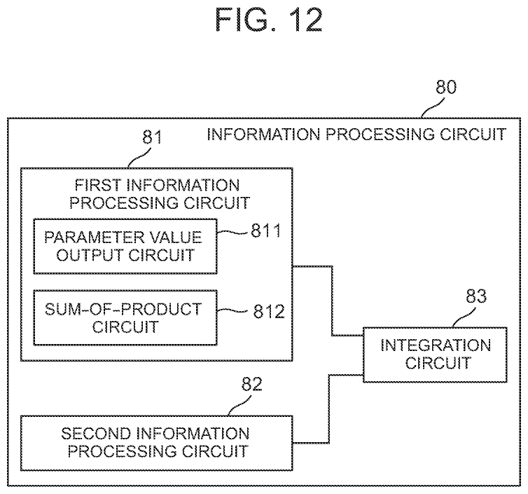

FIG. 12 is a block diagram showing the main part of the information processing circuit. The information processing circuit 80 comprises a first information processing circuit 81 (in the example embodiments, realized by the first information processing circuit 10) that performs layer operations in deep learning, a second information processing circuit 82 (in the example embodiments, realized by the second information processing circuit 20) that performs the layer operations in deep learning on input data by means of a programmable accelerator, and an integration circuit 83 (in the example embodiments, realized by the integration circuit 30) integrates a calculation result of the first information processing circuit 81 with a calculation result of the second information processing circuit 82, and output an integration result, wherein the first information processing circuit 81 includes a parameter value output circuit 811 (in the example embodiments, realized by the parameter value output circuit 102) in which parameters of deep learning are circuited, and a sum-of-product circuit 812 (in the example embodiments, realized by the sum-of-product circuit 101) that performs a sum-of-product operation using the input data and the parameters.

A part of or all of the above example embodiments may also be described as, but not limited to, the following Supplementary notes.

(Supplementary note 1) An information processing circuit comprises:
a first information processing circuit that performs layer operations in deep learning;
a second information processing circuit that performs the layer operations in deep learning on input data by means of a programmable accelerator; and
an integration circuit integrates a calculation result of the first information processing circuit with a calculation result of the second information processing circuit, and output an integration result,
wherein the first information processing circuit includes:
a parameter value output circuit in which parameters of deep learning are circuited; and
a sum-of-product circuit that performs a sum-of-product operation using the input data and the parameters.

(Supplementary note 2) The information processing circuit according to Supplementary note 1,
wherein the integration circuit accepts the calculation results of the first information processing circuit and the second information processing circuit as inputs, integrates the calculation results by calculating a weighted sum of accepted inputs, and output the integration result.

(Supplementary note 3) The information processing circuit according to Supplementary note 1 or 2,
wherein the integration circuit accepts the calculation results of the first information processing circuit and the second information processing circuit as inputs to the layers in deep learning, and outputs a calculation result based on the accepted inputs as an integration result.

(Supplementary note 4) The information processing circuit according to any one of Supplementary notes 1 to 3,
wherein the integration circuit performs layer operations in deep learning by means of a programmable accelerator.

(Supplementary note 5) The information processing circuit according to any one of Supplementary notes 1 to 4,
wherein the integration circuit inputs the same input data as the input data accepted by the first information processing circuit and the second information processing circuit, and weights calculation results of the first information processing circuit and the second information processing circuit based on weighting parameters determined according to the input data.

(Supplementary note 6) The information processing circuit according to any one of Supplementary notes 1 to 5,
wherein
the first information processing circuit outputs a calculation result of an intermediate layer in deep learning,
the second information processing circuit performs the layer operations in deep learning using the calculation result of the intermediate layer as input data; and
the integration circuit integrates calculation result of the intermediate layer, the calculation result of the first information processing circuit and the calculation result of the second information processing circuit, and outputs the integration result.

(Supplementary note 7) The information processing circuit according to Supplementary note 6,
wherein the first information processing circuit outputs an output from the intermediate layer that performs feature extraction as the calculation result.

(Supplementary note 8) The information processing circuit according to any one of Supplementary notes 1 to 7, further comprising a learning circuit which inputs the calculation result on the input data of the integration circuit and a correct answer label for the input data, and learns the parameters of the layers in deep learning,
wherein the learning circuit corrects at least one of the parameters of the integration circuit and the second information processing circuit based on a difference between the calculation result and the correct answer label.

(Supplementary note 9) A deep learning method comprises:
integrating first calculation results of layer operations in deep learning by a first information processing circuit which includes a parameter value output circuit in which parameters of deep learning are circuited and a sum-of-product circuit that performs a sum-of-product operation using input data and parameters, and second calculation results by a second information processing circuit as a programmable accelerator that performs the layer operations in deep learning using the input data; and
outputting an integration result.

(Supplementary note 10) The deep learning method according to Supplementary note 9, further comprising:
accepting weighting results as inputs obtained by weighting the calculation results of the first information processing circuit and the second information processing circuit, and
integrating the calculation results by calculating a weighted sum accepted inputs, and output the integration result.

(Supplementary note 11) A computer readable recording medium storing a program executing deep learning, the program causing a processor to execute:
an integration process integrating first calculation results of layer operations in deep learning by a first information processing circuit which includes a parameter value output circuit in which parameters of deep learning are circuited and a sum-of-product circuit that performs a sum-of-product operation using input data and parameters, and second calculation results by a second information processing circuit as a programmable accelerator that performs the layer operations in deep learning using the input data, and outputting an integration result.

(Supplementary note 12) The recording medium according to Supplementary note 11, wherein
the program causes the processor to further execute:
accepting weighting results as inputs obtained by weighting the calculation results of the first information processing circuit and the second information processing circuit, and
integrating the calculation results by calculating a weighted sum accepted inputs, and output the integration result.

(Supplementary note 13) A learning program executing deep learning causing a computer to execute:
an integration process integrating first calculation results of layer operations in deep learning by a first information processing circuit which includes a parameter value output circuit in which parameters of deep learning are circuited and a sum-of-product circuit that performs a sum-of-product operation using input data and parameters, and second calculation results by a second information processing circuit as a programmable accelerator that performs the layer operations in deep learning using the input data, and outputting an integration result.

(Supplementary note 14) The learning program executing deep learning according to Supplementary note 13, causing the computer to further execute:
accepting weighting results as inputs obtained by weighting the calculation results of the first information processing circuit and the second information processing circuit, and
integrating the calculation results by calculating a weighted sum accepted inputs, and output the integration result.
Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

1, 2, 3, 4, 5 Layer
10, 11, 12 First information processing circuit
20, 21, 22 Second information processing circuit
30, 31, 32 Integration circuit
40, 41, 42 Learning circuit
50, 51, 52 Information processing circuit
60, 61, 62 Information processing circuits
101 Sum-of-product circuit
1011, 1012, 1013, 1014, 1015 Circuit
102 Parameter value output circuit
1021, 1022, 1023, 1024, 1025 Parameter
201, 211, 221 Operator
202, 212, 222 DRAM
80 Information processing circuit
81 First information processing circuit
811 Parameter value output circuit
812 Sum-of-product circuit
82 Second information processing circuit
83 Integration circuit
1000 CPU
1001 Storage device
1002 Memory

What is claimed is:

1. An information processing circuit comprises:
a first information processing circuit that performs layer operations in deep learning;
a second information processing circuit that performs the layer operations in deep learning on input data by means of a programmable accelerator; and
an integration circuit integrates a calculation result of the first information processing circuit with a calculation result of the second information processing circuit, and output an integration result,
wherein the first information processing circuit includes:
a parameter value output circuit in which parameters of deep learning are circuited; and
a sum-of-product circuit that performs a sum-of-product operation using the input data and the parameters.

2. The information processing circuit according to claim 1,
wherein the integration circuit accepts the calculation results of the first information processing circuit and the second information processing circuit as inputs, integrates the calculation results by calculating a weighted sum of accepted inputs, and output the integration result.

3. The information processing circuit according to claim 1,
wherein the integration circuit accepts the calculation results of the first information processing circuit and the second information processing circuit as inputs to the layers in deep learning, and outputs a calculation result based on the accepted inputs as an integration result.

4. The information processing circuit according to claim 1,
wherein the integration circuit performs layer operations in deep learning by means of a programmable accelerator.

5. The information processing circuit according to claim 1,
wherein the integration circuit inputs the same input data as the input data accepted by the first information processing circuit and the second information processing circuit, and weights calculation results of the first information processing circuit and the second information processing circuit based on weighting parameters determined according to the input data.

6. The information processing circuit according to claim 1,
wherein
the first information processing circuit outputs a calculation result of an intermediate layer in deep learning,
the second information processing circuit performs the layer operations in deep learning using the calculation result of the intermediate layer as input data; and
the integration circuit integrates calculation result of the intermediate layer, the calculation result of the first information processing circuit and the calculation result of the second information processing circuit, and outputs the integration result.

7. The information processing circuit according to claim 6,
wherein the first information processing circuit outputs an output from the intermediate layer that performs feature extraction as the calculation result.

8. The information processing circuit according to claim 1, further comprising a learning circuit which inputs the calculation result on the input data of the integration circuit and a correct answer label for the input data, and learns the parameters of the layers in deep learning,
wherein the learning circuit corrects at least one of the parameters of the integration circuit and the second information processing circuit based on a difference between the calculation result and the correct answer label.

9. A deep learning method comprises:
integrating first calculation results of layer operations in deep learning by a first information processing circuit which includes a parameter value output circuit in which parameters of deep learning are circuited and a sum-of-product circuit that performs a sum-of-product operation using input data and parameters, and second calculation results by a second information processing circuit as a programmable accelerator that performs the layer operations in deep learning using the input data; and
outputting an integration result.

10. The deep learning method according to claim 9, further comprising:
accepting weighting results as inputs obtained by weighting the calculation results of the first information processing circuit and the second information processing circuit, and
integrating the calculation results by calculating a weighted sum accepted inputs, and output the integration result.

11. A non-transitory computer readable recording medium storing a program executing deep learning, the program causing a processor to execute:
an integration process integrating first calculation results of layer operations in deep learning by a first information processing circuit which includes a parameter value output circuit in which parameters of deep learning are circuited and a sum-of-product circuit that performs a sum-of-product operation using input data and parameters, and second calculation results by a second information processing circuit as a programmable accelerator that performs the layer operations in deep learning using the input data, and outputting an integration result.

12. The non-transitory computer readable recording medium according to claim 11, wherein
the program causes the processor to further execute:
accepting weighting results as inputs obtained by weighting the calculation results of the first information processing circuit and the second information processing circuit, and
integrating the calculation results by calculating a weighted sum accepted inputs, and output the integration result.
